(19) United States
(12) Patent Application Publication
(10) Pub. No.: US 2026/0205403 A1
(43) Pub. Date: Jul. 16, 2026

(54) SYSTEMS AND METHODS FOR OAM TRIGGERED SERVICE BEHAVIORS

(71) Applicant: Verizon Patent and Licensing Inc., Basking Ridge, NJ (US)

(72) Inventor: Jeremy M. Whittaker, Broken Arrow, OK (US)

(21) Appl. No.: 19/022,434

(22) Filed: Jan. 15, 2025

(51) Int. Cl. H04L 43/16; H04L 43/0852

(52) U.S. Cl. CPC H04L 43/16; H04L 43/0852

(57) ABSTRACT

A device may include a processor configured to establish a link in an Ethernet Virtual Circuit (EVC) connection; determine a service requirement associated with the EVC connection; and monitor the established link for a threshold associated with the determined service requirement. The processor is further configured to detect that the threshold associated with the determined service requirement has been exceeded; and clamp the EVC connection, wherein the clamping reduces the throughput of the EVC connection to zero, in response to detecting that the threshold associated with the determined service requirement has been exceeded.

### BACKGROUND INFORMATION

Providers of communication services may manage wired and/or wireless services in a communication network. Such services may include a managed connection between private networks at different sites associated with a customer of the provider. The managed connection may be associated with one or more service requirements. Monitoring and enforcing such service requirements may pose various difficulties.

### BRIEF DESCRIPTION OF THE DRAWINGS

FIG. 1 illustrates an environment according to an implementation described herein;

FIG. 2 illustrates exemplary components of a device that may be included in an environment according to an implementation described herein;

FIG. 3 illustrates exemplary components of a network device according to an implementation described herein;

FIG. 4 illustrates exemplary components of an Operations, Administration, and Maintenance (OAM) policer according to an implementation described herein;

FIG. 5 illustrates exemplary components of a clamping database according to an implementation described herein;

FIG. 6 illustrates a first flowchart of a process for clamping an Ethernet Virtual Circuit (EVC) according to an implementation described herein;

FIG. 7 illustrates a second flowchart of a process for clamping an EVC according to an implementation described herein; and

FIG. 8 illustrates an exemplary EVC and a corresponding flowchart according to an implementation described herein.

### DETAILED DESCRIPTION OF PREFERRED EMBODIMENTS

The following detailed description refers to the accompanying drawings. The same reference numbers in different drawings identify the same or similar elements.

A provider of communication services may provide an Ethernet Virtual Circuit (EVC) service for customers. An EVC may generate a data link layer connection between two endpoints to enable an Ethernet connection between the two endpoints. Thus, a customer maintaining multiple private Local Area Networks (LANs) may connect the LANs through a provider’s network using an EVC. Furthermore, an EVC may support multiple Virtual LAN (VLAN) labels, enabling the customer to extend multiple VLANs across customer’s networks. An EVC may be dynamically routed through multiple network devices, such as routers and/or switches, in the provider’s network. The particular network devices implementing the EVC through the provider network may change over time based on loading conditions, throughput capacity, latency, and/or other parameters.

An EVC may be associated with a service requirement, such as, for example, a latency requirement. The EVC circuit may experience a condition in which the service requirement cannot be satisfied and yet the EVC circuit may continue to function. A customer may not be able to identify that the EVC circuit is functioning without satisfying the service requirement. Therefore, a customer may prefer that an EVC circuit stop functioning when the service requirement is not being satisfied.

A network device, such as a router, switch, firewall, and/or another type of network device, may include an Operations, Administration, and Maintenance (OAM) policer. The OAM policer may function in the data plane of the network device to process OAM data units (e.g., packets, Ethernet frames, etc.) and/or execute OAM functions. For example, an OAM policer may send OAM data units through the network device, and/or to a neighboring network device, in order to determine the performance of the network device. The OAM data units may be used, for example, to measure parameters such as latency, packet loss, jitter, loss of connectivity, etc., associated with the network device.

Implementations described herein relate to systems and methods for OAM triggered service behaviors. An OAM policer may be configured to trigger behaviors in the data plane of a network device based on measurements performed by the OAM policer. For example, the OAM policer may be configured to clamp an EVC by reducing the data rate of the EVC to zero.

For example, a network device may be configured to establish a link in an EVC connection, determine a service requirement associated with the EVC connection, configure the established link based on the determined service requirement, and monitor the established link for a threshold associated with the determined service requirement. The network device may be further configured to detect that the threshold associated with the determined service requirement has been exceeded and clamp the EVC connection, in response to detecting that the threshold associated with the determined service requirement has been exceeded. “Clamping,” as the term is used herein, refers to reducing the throughput of an EVC connection to zero while the clamping is in effect.

The network device may include a router, a switch, a firewall, and/or another type of network device that may participate in implementing an EVC connection. The service requirement may include, for example, a latency requirement, a packet loss rate requirement, a jitter requirement, a connectivity requirement, and/or another type of requirement associated with a network Key Performance Indicator (KPI) parameter.

Detecting that the threshold associated with the determined service requirement has been exceeded may include detecting that the threshold associated with the determined service requirement has been exceed for at least a threshold length of time. Ensuring that the threshold has been exceeded for a threshold length of time may ensure that the clamping is not activated as a result of short duration drops in the performance of the EVC connection.

In some implementations, monitoring the established link for the threshold associated with the determined service requirement, detecting that the threshold has been exceeded, and clamping the EVC connection may be performed by an OAM policer in the network device. For example, a control plane controller of the network device may configure the OAM policer to monitor the established link for the threshold associated with the service requirement and to perform the clamping in response to the threshold associated with the service requirement being exceeded. In other implementations, the monitoring the established link for the threshold associated with the determined service requirement, the detecting that the threshold associated with the determined service requirement has been exceeded, and the clamping the EVC connection may be performed by a different component of the network device, such as, for example, the control plane controller of the network device.

The network device may be configured to perform additional actions in response to detecting that the threshold associated with the determined service requirement has been exceeded. For example, the network device may send an alert to a device of a customer associated with the EVC connection, in response to detecting that the threshold has been exceeded.

The network device may be further configured to continue to monitor the established link for the threshold associated with the determined service requirement, detect that the threshold is no longer exceeded, and cease to clamp the EVC connection, in response to detecting that the threshold is no longer exceeded.

Clamping an EVC connection, in response to a service requirement threshold being exceeded may prevent an EVC, may prevent the EVC connection from functioning when the EVC connection cannot satisfy a service requirement and provide easy-to-decipher information to a customer that the EVC connection is not functioning properly. Without the camping, the customer may not notice that a service requirement is not being satisfied, as the EVC connection may continue to send and receive data units. In contrast, if the EVC connection is clamped, and no data is sent or received via the EVC connection, the customer may notice that the EVC connection is not properly functioning. Furthermore, using an OAM policer to clamp an EVC connection may improve the functionality and/or efficiency of the network device by providing a data plane implementation of the clamping functionality, without requiring control plane and/or management plane configuration changes.

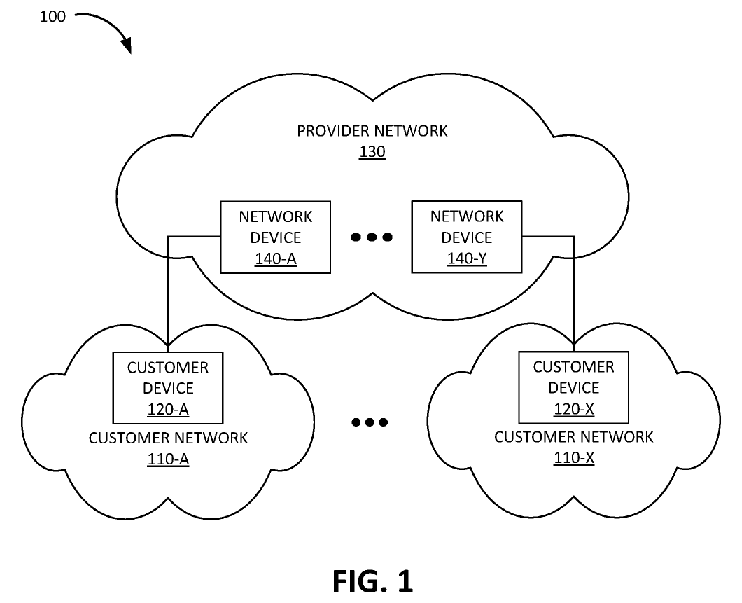

FIG. 1 is a diagram of an exemplary environment 100 in which the systems and methods described herein may be implemented. As shown in FIG. 1, environment 100 may include customer networks 110-A to 110-X (herein collectively referred to as “customer networks 110” and individually as “customer network 110”) and a provider network 130.

Customer network 120 may include, for example, a Local Area Network (LAN) associated with customer premises. For example, customer network 120 may be a LAN in a customer’s office, at business location, in a residence, etc. Customer network 120 may include at least one customer device 120. Customer device 120 may include any device with network communication functionality. For example, customer device 120 may include a gateway, a router, a switch, a firewall, a network interface card (NIC), a hub, a bridge, a proxy server, or another type of network device; a personal computer or workstation; a server device; a portable computer; a WIFI access point (AP), a Fixed Wireless Access (FWA) device; and/or any other type of wireless communication device; a printer, fax machine, or another type of physical medium output device; a television, a projector, a speaker, or another type of a display or audio output device; a set-top box; a gaming system; a camera, a video camera, a microphone, a sensor, or another type of input or content recording device; a handheld wireless communication device (e.g., a mobile phone, a smart phone, a tablet device, etc.); a wearable computer device (e.g., a head-mounted display computer device, a wristwatch computer device, etc.); a voice over Internet Protocol (VoIP) telephone device; and/or any type of device with the capability to communicate over a network.

A customer may manage multiple customer networks 120 and may extend a LAN, and/or multiple Virtual LANs (VLAN), across the multiple customer networks 120 using an EVC established by the provider across provider network 130. Provider network 130 may be managed by the provider of communication services. Provider network 130 may include a wide area network (WAN), a metropolitan area network (MAN), an autonomous system (AS) on the Internet, a LAN, a satellite network, a cellular wireless network, an ad hoc network, a telephone network (e.g., the Public Switched Telephone Network (PSTN)), an intranet, and/or a combination thereof.

Provider network 130 may include network devices 140-A to 140-Y (herein collectively referred to as “network devices 140” and individually as “network device 140”). Network device 140 may include a gateway, a router, a switch and/or another type of network device which enable establishment of a link in an EVC connection. Network device 140 may be configured to clamp an EVC by reducing the data rate of the EVC to zero in response to determining that a threshold, associated with a service requirement for the EVC, has been exceeded.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

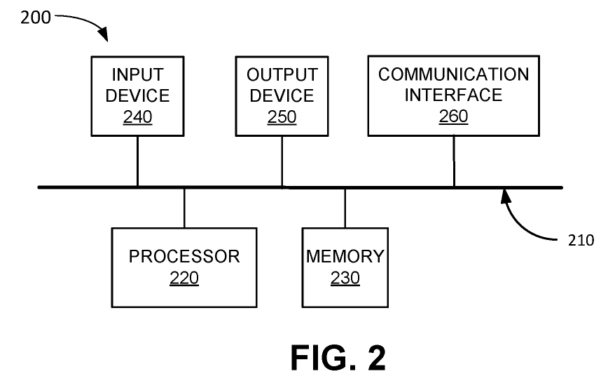

FIG. 2 is a diagram illustrating example components of a device 200 according to an implementation described herein. The components of FIG. 1 may each include one or more of device 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logic) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that stores information and/or instructions, for execution by processor 220, and/or any type of non-volatile storage device that stores information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some implementations, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a liquid-crystal display (LCD), a Light Emitting Diode (LED) display, and/or another type of display. In some implementations, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to an antenna for transmitting and receiving RF signals.

Communication interface 260 may include a logical component that includes input and/or output ports and/or other input and output components that facilitate the transmission of data to other devices. For example, communication interface 260 may include a network interface card (e.g., Ethernet card) for wired communications and/or a wireless network interface (e.g., a WIFI) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface.

As will be described in detail below, device 200 may perform certain operations relating to OAM triggered service behaviors. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

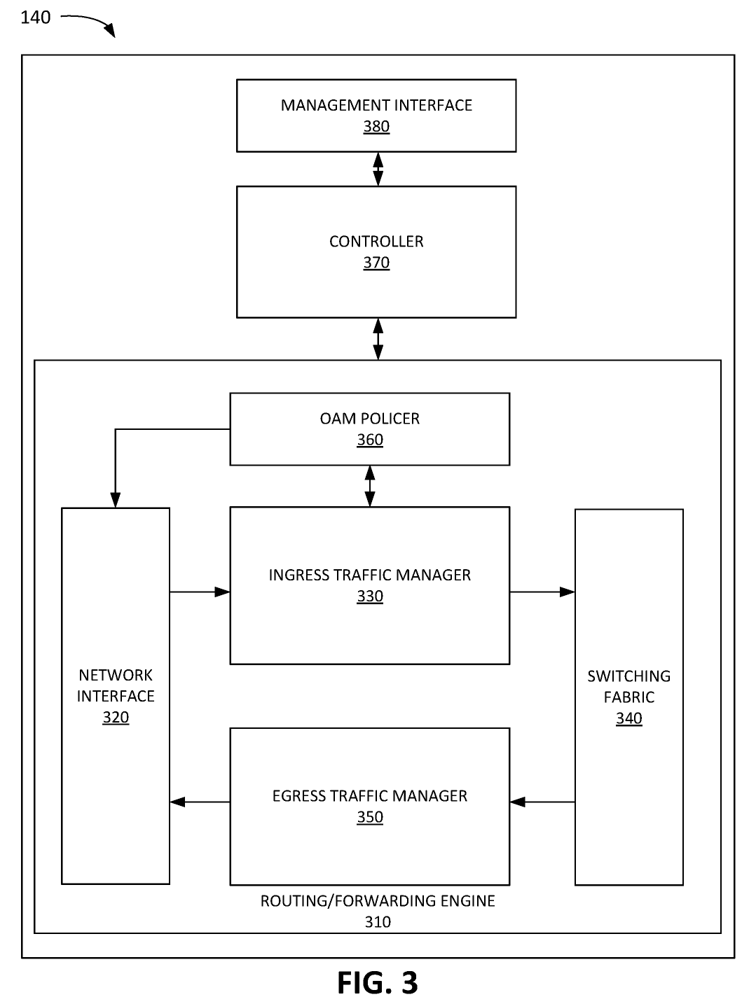

FIG. 3 illustrates exemplary components of network device 140. The components of network device 140 may be implemented, for example, via processor 220 executing instructions from memory 230. For example, one or more components of network device 140 may correspond to the structure of processor 220 together with instructions in memory 230 for implementing the functionality of the component. Alternatively, some or all of the components of network device 140 may be implemented via hard-wired circuitry. For example, components of UE device 110 may correspond to an ASIC, FPGA, and/or another type of integrated circuit. As shown in FIG. 3, network device 140 may include a routing/forwarding engine 310, a controller 370, and a management interface 380.

Routing/forwarding engine 310 may perform forwarding and/or routing operations on data units (e.g., packet, frames, etc.) received by network device 140. Routing/forwarding engine 310 may include a network interface 320, an ingress traffic manager 330, a switching fabric 340, an egress traffic manager 350, and an OAM policer 360.

Network interface 320 may include a set of physical networking ports and associated functionality to enable the operation of the ports. The ports may include Ethernet ports; Optical Transport Network (OTN) ports; wireless transceivers for communicating with a cellular wireless base station and/or a satellite; and/or other types of ports.

Ingress traffic manager 330 may manage ingress traffic received via network interface 320. For example, ingress traffic manager 330 may parse and classify an incoming data unit, select a queue based on a classification of the data unit and place the incoming data unit into the selected queue, determine an egress port for the incoming data unit based on a forwarding and/or routing table maintained by ingress traffic manager 330, encapsulate the data unit with information required for egress processing, and/or perform other types of ingress traffic management. Ingress traffic manager 330 may drop a data unit based on a classification of the data unit. For example, if the data unit is associated with a clamped EVC connection, ingress traffic manager 330 may drop the data unit.

Switching fabric 340 may connect ingress data pipes to egress data pipes via a set of network switches. Egress traffic manager 350 may enqueue q data unit based on class of service requirements, removing any headers or other information added during processing of the data unit by ingress traffic manager 330, encapsulate the data unit by adding Layer 2 and/or Layer 3 headers, and/or perform other types of egress traffic management before forwarding the data unit to a particular egress port. In some implementations, egress traffic manager 340 may perform clamping of an EVC connection instead of, or in addition to, any EVC clamping performed by ingress traffic manager 330.

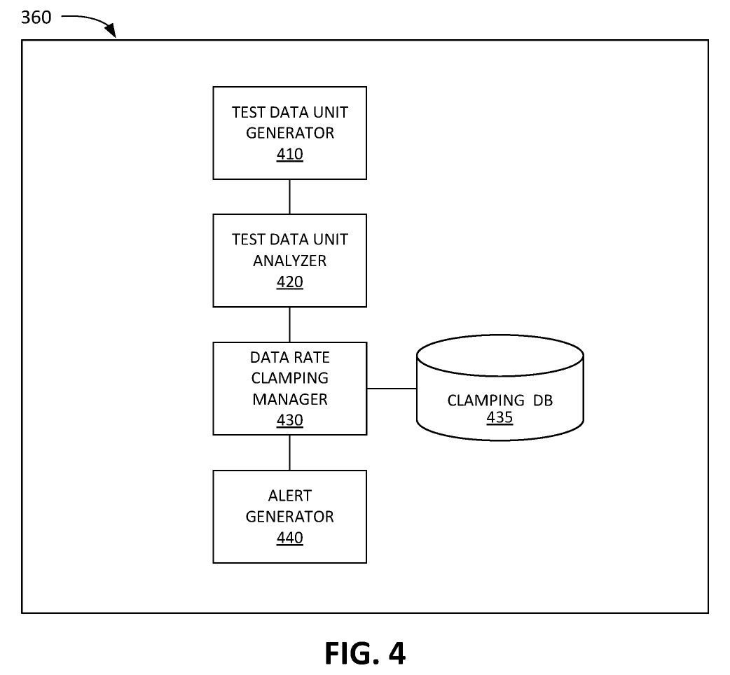

OAM policer 360 may generate and process OAM data units and may execute OAM functions. The OAM data units may include test data units to measure the latency, packet loss, jitter, connectivity status, and/or other parameters between particular ingress ports and egress ports and/or between a particular ingress port or egress port and another network device 140. Furthermore. OAM policer 360 may monitor an EVC connection maintained by network device 140 and may clamp the EVC connection if a threshold associated with the EVC connection is exceeded. Exemplary components of OAM policer 360 are described below with reference to FIG. 4.

Controller 370 may perform control plane processing in network device 140. For example, controller 370 may update a forwarding and/or routing table maintained by routing/forwarding engine 310. Controller 370 may further configure routing/forwarding engine 310 with respect to particular service requirements. For example, controller 370 may configure routing/forwarding engine 310 to establish a link in an EVC connection. In establishing the EVC connection, controller 370 may identify an ingress port associated with a link to another network device 140 (or customer device 120) through which the EVC connection interconnects and/or an egress port associated with a link to another network device 140 (or customer device 120) through which the EVC connection interconnects, and configure routing/forwarding engine 310 to forward and/or route data units associated with the EVC connection between the identified ingress port and the identified egress port. Furthermore, controller 370 may configure ingress traffic manager 330 to maintain one or more service requirements associated with the EVC connection. For example, controller 370 may configure ingress traffic manager 330 to process data units associated with the EVC connection based on a class of service associated with a service requirement for the EVC connection.

Additionally, controller 370 may configure OAM policer 360 to monitor an EVC connection and perform clamping in the EVC connection based on a requirement associated with the EVC connection. In some implementations, controller 370 may perform the monitoring of the EVC connection and/or the clamping of the EVC connection based on the requirement associated with the EVC connection directly, without involving the OAM policer 360.

Management interface 380 may perform management plane processing in network device 140. Management interface 380 may provide an interface configured to enable an administrator to send instructions to controller 370. For example, the interface may enable the administrator to instruct controller 370 to configure OAM policer 360 to monitor an EVC connection and perform clamping in the EVC connection based on a requirement associated with the EVC connection.

Although FIG. 3 shows exemplary components of network device 140, in other implementations, network device 140 may include fewer components, different components, additional components, or differently arranged components than depicted in FIG. 3. Additionally, or alternatively, one or more components of network device 140 may perform one or more tasks described as being performed by one or more other components of network device 140.

FIG. 4 illustrates exemplary components of OAM policer 360. The components of OAM policer 360 may be implemented, for example, via processor 220 executing instructions from memory 230. For example, one or more components of OAM policer 360 may correspond to the structure of processor 220 together with instructions in memory 230 for implementing the functionality of the component. Alternatively, some or all of the components of OAM policer 360 may be implemented via hard-wired circuitry. As shown in FIG. 4 OAM policer 360 may include a test data unit generator 410, a test data unit analyzer 420, a data rate clamping manager 430, a clamping database (DB) 435, and an alert generator 440.

Test data unit generator 410 may generate test data units to measure the latency, packet loss, jitter, connectivity status, and/or other parameters between particular ingress ports and egress ports and/or between a particular ingress port or egress port and another network device 140. For example, test data unit generator 410 may inject a test data unit into network interface 320 and/or ingress traffic manager 330. Test data unit analyzer 420 may analyze test data units sent through switching fabric 340 and/or received from an OAM policer 360 in another network device 140. Test data unit analyzer 420 may determine a latency value, a packet loss rate value, a jitter value, a connectivity status value, and/or a value for another network performance parameter associated with a particular path through network device 140 and/or between network device 140 and another network device 140.

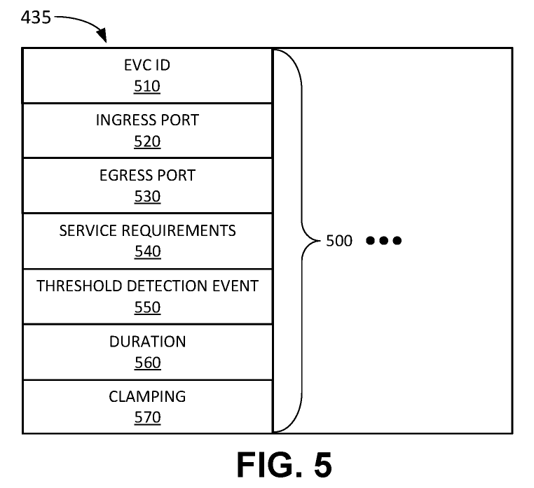

Data rate clamping manager 430 may determine whether to clamp an EVC connection based on information received from test data unit analyzer 420 and based on information stored in clamping DB 435. Clamping DB 435 may store information relating to clamping conditions for particular EVC connections. Exemplary information that may be store in clamping DB 435 is described below with reference to FIG. 5.

Data rate clamping manager 430 may monitor an EVC connection for one or more thresholds associated with service requirements for the EVC connection and clamp the EVC connection if at least one of the one or more thresholds has been exceeded. For example, data rate clamping manager 430 may instruct ingress traffic manager 330 to drop all data units associated with the EVC connection while EVC connection is dropped, thereby reducing the throughput of the EVC connection to zero. Data rate clamping manager 430 may continue to monitor the EVC connection and may cease to clamp the EVC connection if data rate clamping manager 430 determines that the threshold is no longer being exceeded.

Alert generator 440 may generate an alert in response to clamping an EVC connection and send the generated alert to a designated device associated with the EVC connection. For example, alert generator 440 may send an alert message to customer device 120 indicating that the EVC connection has been clamped and/or providing a reason for why the EVC connection has been clamped.

Although FIG. 4 shows exemplary components of OAM policer 360, in other implementations, OAM policer 360 may include fewer components, different components, additional components, or differently arranged components than depicted in FIG. 4. Additionally, or alternatively, one or more components of OAM policer 360 may perform one or more tasks described as being performed by one or more other components of OAM policer 360.

FIG. 5 illustrates exemplary components of clamping DB 435. As shown in FIG. 5, clamping DB 435 may include one or more clamping condition records 500. Each clamping condition record 500 may include information relating to clamping conditions for a particular EVC connection. Clamping condition record 500 may include an EVC ID field 510, an ingress port field 520, an egress port field 530, a service requirements field 540, a threshold detection event field 550, a duration field 560, and a clamping field 570.

EVC ID field 510 may identify a particular EVC connection managed by network device 140. For example, EVC ID field 510 may identify an ID included in an EVC header, and/or another type of identifying field, included in data units associated with the particular EVC connection. Ingress port field 520 may identify the ingress port associated with the particular EVC connection. Egress port field 530 may identify an egress port associated with the particular EVC connection.

Service requirements field 540 may store information identifying one or more service requirements associated with the particular EVC connection. For example, service requirements field 540 may include information identifying a latency requirement, a packet loss requirement, a jitter requirement, a connectivity requirement, and/or a requirement associated with another EVC performance parameter. A latency requirement may include a requirement for a maximum allowable end-to-end latency and an associated threshold, a maximum allowable average latency defined over a specified time period and an associated threshold, and/or another type of latency requirement and/or threshold. A packet loss rate requirement may include a requirement for a maximum allowable packet loss rate and an associated threshold, a maximum allowable average packet loss rate defined over a specified time period and an associated threshold, and/or another type of packet loss rate requirement and/or threshold. A jitter requirement may include a requirement for a maximum allowable jitter and an associated threshold, a maximum allowable average jitter defined over a specified time period and an associated threshold, and/or another type of jitter requirement and/or threshold. A connectivity requirement may include a no loss of connectivity requirement, a requirement for a minimum percentage connectivity within a time period and/or another type of connectivity requirement. Furthermore, a particular service requirement threshold may be associated with a duration threshold. Thus, the particular service requirement may need to be exceeded for at least the duration threshold in order to trigger clamping of the EVC connection. A threshold may be based on an absolute value, such as, for example, a value of 10 milliseconds for a latency threshold. Alternatively, a threshold may be based on a percentage, such as, for example, a 5% loss for a packet loss rate. Some thresholds may include an upper bound and a lower bound.

Threshold detection event field 550 may store information identifying whether a threshold detection event has been detected for the particular EVC connection, indicating that a threshold associated with a service requirement for the particular EVC connection has been exceeded. Duration field 560 may store information identifying a duration of the threshold being exceeded. Clamping field 570 may store information indicating whether the EVC connection is currently clamped. If the EVC connection is clamped, clamping field 570 may store information indicating how long the EVC connection has been clamped, and/or the reasons for clamping the EVC connection.

Although FIG. 5 shows exemplary components of clamping DB 435, in other implementations, clamping DB 435 may include fewer components, different components, additional components, or differently arranged components than depicted in FIG. 5.

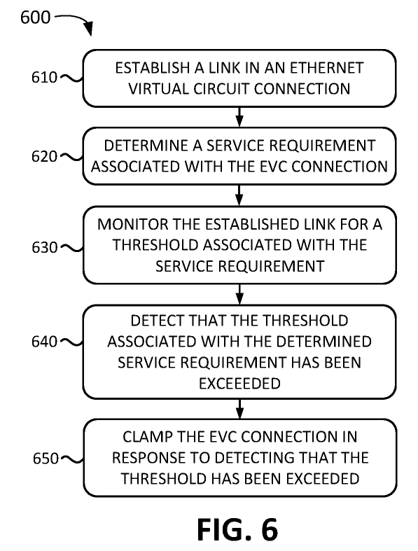

FIG. 6 illustrates a first flowchart of a process for clamping an EVC connection. In some implementations, process 600 of FIG. 6 may be performed by network device 140. In other implementations, some or all of process 600 may be performed by another device or a group of devices separate from network device 140.

As shown in FIG. 6, process 600 may include establishing a link in an EVC connection (block 610). For example, network device 140 may select an ingress port associated with a link to another network device 140 (or customer device 120) through which the EVC connection interconnects, select an egress port associated with a link to another network device 140 (or customer device 120) through which the EVC connection interconnects, and configure forwarding and/or routing data units associated with the EVC connection between the selected ingress and egress ports.

Process 600 may further include determining a service requirement associated with the EVC connection (block 620) and monitoring the established link for a threshold associated with the service requirement (block 630). For example, network device 140 may configure processing of data units associated with the EVC connection based on a class of service associated with a service requirement for the EVC connection. Network device 140 may then monitor the EVC connection for one or more thresholds associated with the service requirements for the EVC connection, such as, for example, a latency threshold, a packet loss threshold, a jitter threshold, a connectivity threshold, and/or another type of service requirement threshold.

Process 600 may further include detecting that the threshold associated with the determined service requirement has been exceeded (block 640) and clamping the EVC connection in response to detecting that the threshold has been exceeded (block 650). For example, network device 140 may detect that one or more thresholds associated with the service requirements for the EVC connection has been exceeded and clamp the EVC connection in response. For example, network device 140 may drop all data units associated with the EVC connection while the EVC connection is clamped, thereby reducing the throughput of the EVC connection to zero.

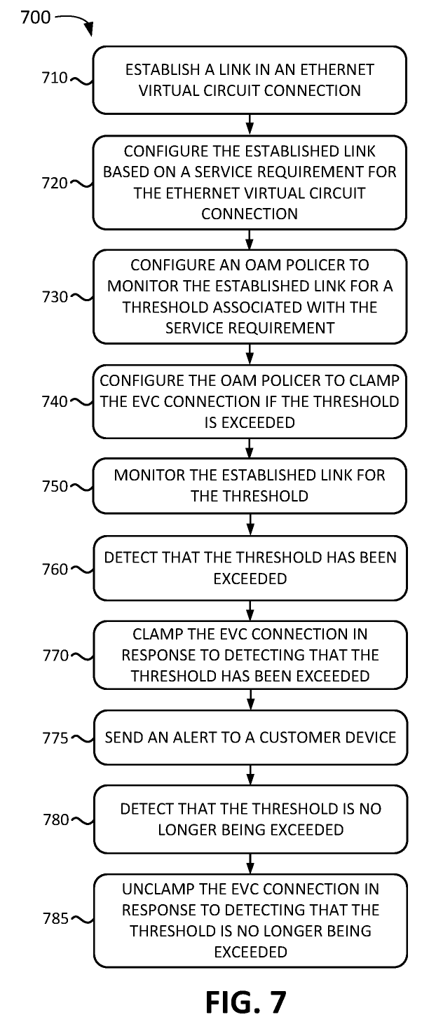

FIG. 7 illustrates a second flowchart of a process 700 for clamping an EVC connection. In some implementations, process 700 of FIG. 7 may be performed by network device 140. In other implementations, some or all of process 700 may be performed by another device or a group of devices separate from network device 140.

As shown in FIG. 7, process 700 may include establishing a link in an EVC connection (block 710) and configuring the established link based on a service requirement for the EVC connection (block 720). For example, network device 140 may select an ingress port associated with a link to another network device 140 (or customer device 120) through which the EVC connection interconnects, select an egress port associated with a link to another network device 140 (or customer device 120) through which the EVC connection interconnects, and configure forwarding and/or routing data units associated with the EVC connection between the selected ingress and egress ports. Furthermore, network device 140 may configure processing of data units associated with the EVC connection based on a class of service associated with a service requirement for the EVC connection.

Process 700 may further include configuring an OAM policer to monitor the established link for a threshold associated with the service requirement (block 730) and configuring the OAM policer to clamp the EVC connection if the threshold is exceeded (block 740). For example, network device 140 may configure OAM policer 360 to monitor the EVC connection and perform clamping in the EVC connection based on a requirement associated with the EVC connection, such as a latency requirement, a packet loss requirement, a jitter requirement, a connectivity requirement, and/or a requirement associated with another EVC performance parameter.

Process 700 may further include monitoring the established link for the threshold (block 750), detecting that the threshold has been exceeded (block 760), and clamping the EVC connection in response to detecting that the threshold has been exceeded (block 770). For example, network device 140 may monitor the EVC connection for one or more thresholds associated with the service requirements for the EVC connection and clamp the EVC connection if at least one of the one or more thresholds has been exceeded. For example, network device 140 may drop all data units associated with the EVC connection while the EVC connection is clamped, thereby reducing the throughput of the EVC connection to zero.

Process 700 may further include sending an alert to a customer device (block 775). For example, network device 140 may generate an alert in response to an EVC connection being clamped and send the generated alert to a designated device associated with the EVC connection. For example, alert generator 440 may send an alert message to customer device 120 indicating that the EVC connection has been clamped and/or a reason why the EVC connection has been clamped.

Process 700 may further include detecting that the threshold is no longer being exceeded (block 780) and unclamping the EVC connection in response to detecting that the threshold is no longer being exceeded (block 785). For example, network device 140 may continue to monitor the EVC connection and may cease to clamp the EVC connection if network device 140 determines that the threshold is no longer being exceeded.

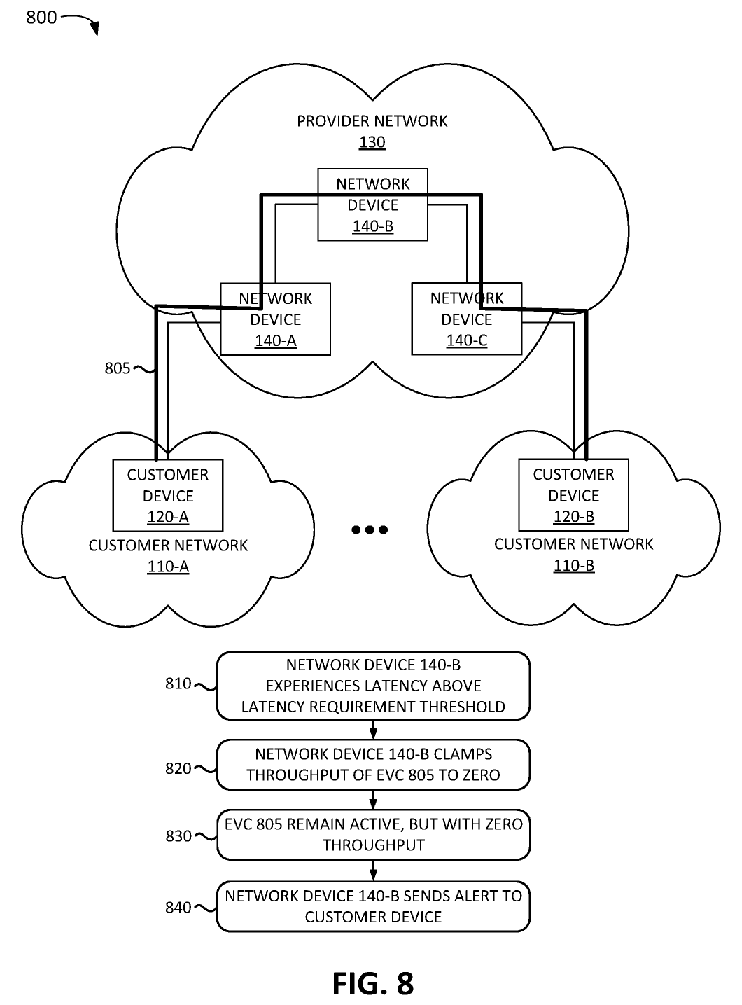

FIG. 8 illustrates an exemplary scenario 800 for an EVC 805 and a corresponding flowchart according to an implementation. EVC 805 may be established between customer network 110-A and customer network 110-B. EVC 805 may include a link from customer device 120-A in customer network 110-A to network device 140-A, a link from network device 140-A to network device 140-B, a link from network device 140-B to network device 140-C, and a link from network device 140-C to customer device 120-B in customer network 110-B. EVC 805 may be associated with a latency requirement for data units between customer device 120-A and customer device 120-B.

Network device 140-B may experience a latency above a latency requirement threshold (block 810). For example, assume network device 140-B becomes overloaded as a result of other connections being processed by network device 140-B. In response, network device 140-B may clamp the throughput of EVC 805 to zero by dropping all the data units labeled as belonging to EVC 805 (block 820). EVC 805 may remain active, but with zero throughput (block 830). Customer device 120-A and/or customer device 120-B may detect that EVC 805 is experiencing zero throughput and may report that EVC 805 is down. Additionally, network device 140-B may send an alert to a customer’s email address, informing the customer that EVC 805 has been clamped (signal 840).

While in some implementations, any network device 140 along EVC 705 may implement and enforce clamping of EVC 705, in other implementations, the clamping may be performed by an ingress device or an egress device associated with EVC 705. The ingress and/or egress device may be designated as service enforcement points. For example, a policer that includes the clamping enforcement mechanism may be implemented on an ingress device, and a Quality of Service queueing/scheduling enforcement mechanism may be implemented on an egress device. Alternatively, the clamping enforcement mechanism may be implemented on both the ingress and the egress devices. Thus, the clamping mechanism may be implemented and enforced by network device 140-A and/or network device 140-C. In such an implementation, network devices 140 in the middle of EVC 705 (e.g., network devices 140 that are not ingress or egress devices with respect to EVC 705, etc.) may remain agnostic with respect to the clamping mechanism.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 6 and 7, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code--it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises” / “comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article "a" is intended to include one or more items. Further, the phrase "based on" is intended to mean "based, at least in part, on" unless explicitly stated otherwise.

What is claimed is:

1. A method comprising:
establishing, by a network device, a link in an Ethernet Virtual Circuit (EVC) connection;
determining, by the network device, a service requirement associated with the EVC connection;
monitoring, by the network device, the established link for a threshold associated with the determined service requirement;
detecting, by the network device, that the threshold associated with the determined service requirement has been exceeded; and
clamping, by the network device, the EVC connection, wherein the clamping reduces a throughput of the EVC connection to zero, in response to detecting that the threshold associated with the determined service requirement has been exceeded.

2. The method of claim 1, further comprising:
configuring the established link based on the service requirement associated with the EVC connection;
configuring, the network device to monitor the established link for the threshold associated with the service requirement; and
configuring the network device to perform at least one action in response to the threshold associated with the service requirement being exceeded.

3. The method of claim 1, wherein the network device includes a router or a switch.

4. The method of claim 1, wherein the monitoring the established link for the threshold associated with the determined service requirement, the detecting that the threshold associated with the determined service requirement has been exceeded, and the clamping the EVC connection are performed by an Operations, Administration, and Maintenance (OAM) policer in the network device.

5. The method of claim 4, further comprising:
configuring the OAM policer to monitor the established link for the threshold associated with the service requirement; and
configuring the OAM policer to perform the clamping in response to the threshold associated with the service requirement being exceeded.

6. The method of claim 1, wherein the service requirement includes a latency requirement.

7. The method of claim 1, wherein the service requirement includes at least one of:
a packet loss rate requirement;
a jitter requirement; or
a connectivity requirement.

8. The method of claim 1, further comprising:
sending an alert to a device of a customer associated with the EVC connection, in response to detecting that the threshold associated with the determined service requirement has been exceeded.

9. The method of claim 1, wherein detecting that the threshold associated with the determined service requirement has been exceeded includes:
detecting that the threshold associated with the determined service requirement has been exceeded for at least a threshold length of time.

10. The method of claim 1, further comprising:
detecting that the threshold associated with the determined service requirement is no longer exceeded; and
ceasing to clamp the EVC connection, in response to detecting that the threshold associated with the determined service requirement is no longer exceeded.

11. A device comprising:
a processor configured to:
establish a link in an Ethernet Virtual Circuit (EVC) connection;
determine a service requirement associated with the EVC connection;
monitor the established link for a threshold associated with the determined service requirement;
detect that the threshold associated with the determined service requirement has been exceeded; and
clamp the EVC connection, wherein clamping reduces a throughput of the EVC connection to zero, in response to detecting that the threshold associated with the determined service requirement has been exceeded.

12. The device of claim 11, wherein the processor is further configured to:
configure the established link based on the service requirement associated with the EVC connection;
configure the network device to monitor the established link for the threshold associated with the service requirement; and
configure the network device to perform at least one an action in response to the threshold associated with the service requirement being exceeded.

13. The device of claim 11, wherein the device includes a router or a switch.

14. The device of claim 11, wherein the processor is configured to cause an Operations, Administration, and Maintenance (OAM) policer in the device to monitor the established link for the threshold associated with the determined service requirement, detect that the threshold associated with the determined service requirement has been exceeded, and clamp the EVC connection.

15. The device of claim 11, wherein the service requirement includes a latency requirement.

16. The device of claim 11, wherein the service requirement includes at least one of:
a packet loss rate requirement;
a jitter requirement; or
a connectivity requirement.

17. The device of claim 11, wherein the processor is further configured to:
send an alert to a device of a customer associated with the EVC connection, in response to detecting that the threshold associated with the determined service requirement has been exceeded.

18. The device of claim 11, wherein, when detecting that the threshold associated with the determined service requirement has been exceeded, the processor is further configured to:
detect that the threshold associated with the determined service requirement has been exceeded for at least a threshold length of time.

19. The device of claim 11, wherein the processor is further configured to:
detect that the threshold associated with the determined service requirement is no longer exceeded for at least a threshold length of time; and
cease to clamp the EVC connection, in response to detecting that the threshold associated with the determined service requirement is no longer exceeded for at least the threshold length of time.

20. A non-transitory computer-readable memory device storing instructions executable by a processor, the non-transitory computer-readable memory device comprising:
one or more instructions to establish a link in an Ethernet Virtual Circuit (EVC) connection;
one or more instructions to determine a service requirement associated with the EVC connection;
one or more instructions to monitor the established link for a threshold associated with the determined service requirement;
one or more instructions to detect that the threshold associated with the determined service requirement has been exceeded; and
one or more instructions to clamp the EVC connection, wherein clamping reduces a throughput of the EVC connection to zero, in response to detecting that the threshold associated with the determined service requirement has been exceeded.
